(19) United States
(12) Patent Application Publication
(10) Pub. No.: US 2010/0002456 A1
(43) Pub. Date: Jan. 7, 2010

(54) Bicycle Reflector

(76) Inventor: Henkel Lin, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/168,190

(22) Filed: Jul. 7, 2008

(51) Int. Cl. B62J 6/20; B60Q 1/00

(52) U.S. Cl. 362/464; 362/473

(57) ABSTRACT

A bicycle reflector has a case and an electric module. The case has an internal space. The electric module is mounted in the internal space and has a rolling ball switch, a light sensor, multiple light sources, a battery contact and a control board. The control board electronically connects to the rolling ball switch, the light sensor, the light sources and the battery contact. The light sources is controlled by the control board to emit light when the rolling ball switch is moved to electrically short and the light sensor detects a low brightness of environment.

### BACKGROUND OF THE INVENTION

1. Field of Invention

The present invention relates to a bicycle reflector, and more particularly to a luminant reflector that is mounted on spokes of a bicycle wheel.

2. Description of the Related Art

Riding bicycle becomes a very popular activity recently. People like to mount different functional accessories on their bikes to improve safety and facilitation of use, for instance, bottle frames, wheel reflectors, front lights, bags and so on. The wheel reflector is normally mounted on the spokes of the wheel and provides reflection light to give caution to vehicles nearby.

The wheel reflector may be passive or active. The passive wheel reflector reflects lights came from environment or other vehicles. On the other hand, the active wheel reflector includes light emitting diodes (LEDs) or the like light sources to emit light to actively give caution especially in no external light environment. Although the active wheel reflector can emit light to increase safe of use, some disadvantages still exit when using the active wheel reflectors:

1) The present active wheel reflector is turned ON/OFF manually, a battery installed inside the active wheel reflector may fast exhaust power since most of riders might often forget to turn it off.

2) The active wheel reflector does not save power since the active wheel reflector emits light regardless of brightness of the environment. Emitting light continuously is not necessary and the power is therefor wasted when the bicycle passes through a brighten area (e.g. through a brighten tunnel) or stops temporary (e.g. waiting traffic lights).

The present invention provides a bicycle reflector that is capable of automatically turn ON and OFF based on sensed brightness of environment and movement of the bicycle to obviate or mitigate the shortcomings of the conventional reflectors.

### SUMMARY OF THE INVENTION

The primary objective of the present invention is to provide a bicycle reflector that is energy saving by automatically turning ON and OFF based on detected brightness of environment and movement of the bicycle.

The bicycle reflector has a case and an electric module. The case has an internal space. The electric module is mounted in the internal space and has a rolling ball switch, a light sensor, multiple light sources, a battery contact and a control board. The control board electronically connects to the rolling ball switch, the light sensor, the light sources and the battery contact. The light sources is controlled by the control board to emit light when the rolling ball switch is moved to electrically short and the light sensor detects a low brightness of environment.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a bicycle reflector in accordance of the present invention;

FIG. 2 is a rear perspective view of the bicycle reflector in FIG. 1;

FIG. 3 is an exploded perspective view of the bicycle reflector in FIG. 1;

FIG. 4 is an enlarged side view in partial section of an electric module in accordance with the present invention;

FIG. 5 is an electric circuit view of the electric module in accordance with the present invention;

FIG. 6 is an operational perspective view of the bicycle reflector in FIG. 1; and

FIG. 7 is a flow chart of the bicycle reflector in accordance with the present invention.

### DETAILED DESCRIPTION OF THE INVENTION

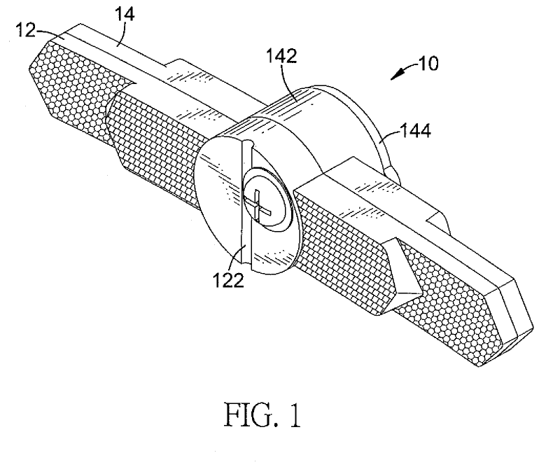

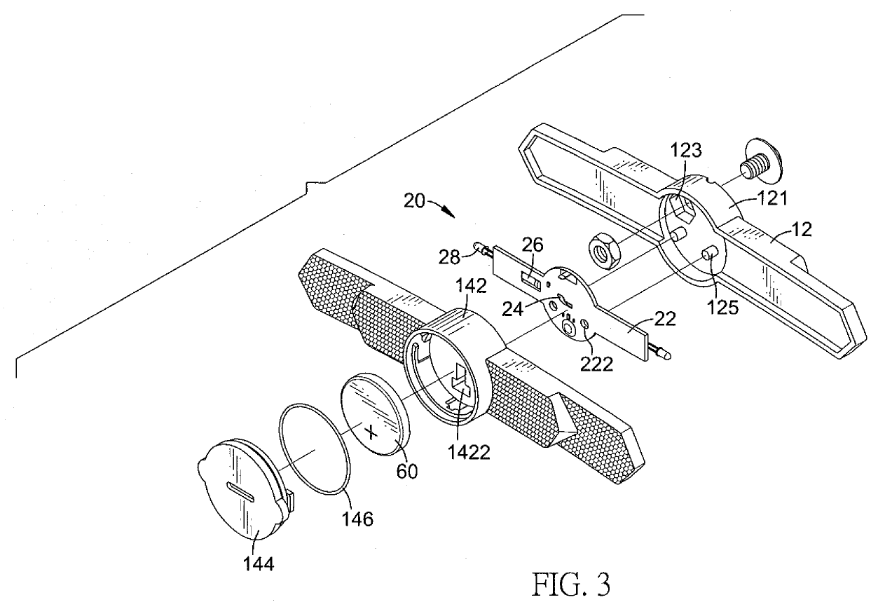

With reference to FIGS. 1 and 3, a bicycle reflector in accordance with the present invention comprises a case (10) and an electric module (20).

The case (10) is a reflector having an internal space, may be arc like, rectangle like or the like and may have a first cover (12) and a second cover (14) that are mounted to each other to form the internal space.

The first cover (12) has a first inner surface, a first outer surface, a spoke recess (122), an optional mounting recess (123) and multiple fixing mounts (125).

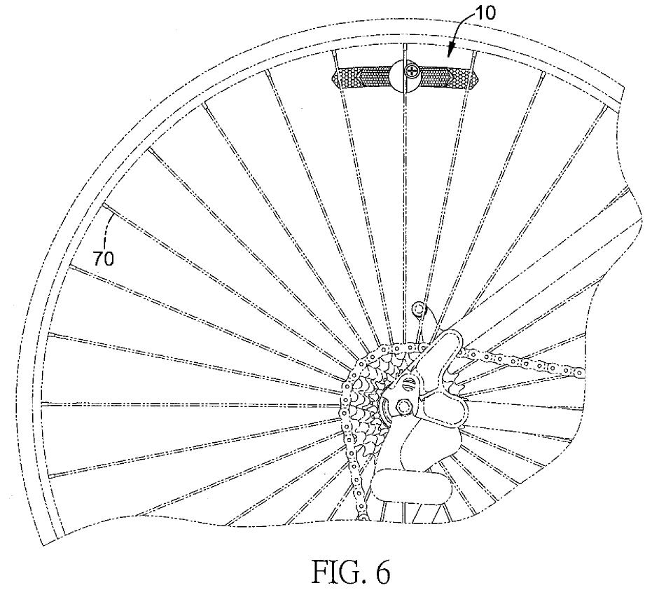

With reference to FIG. 6, the spoke recess (122) is formed on the first outer surface of the first cover (12) and corresponds to and mounts on a spoke (70) of a wheel of a bicycle. In the preferred embodiment, the spoke recess (122) is a straight recess having an arced cross-section.

The mounting recess (123) is a polygon recess formed on the first inner surface of the first cover (12), is disposed corresponding to the spoke recess (122) and is used for holding a nut so that a screw may mount with the nut from the first outer surface and hold the spoke (70) in the spoke recess (122).

The fixing mounts (125) separately protrudes from the first inner surface of the first cover (12).

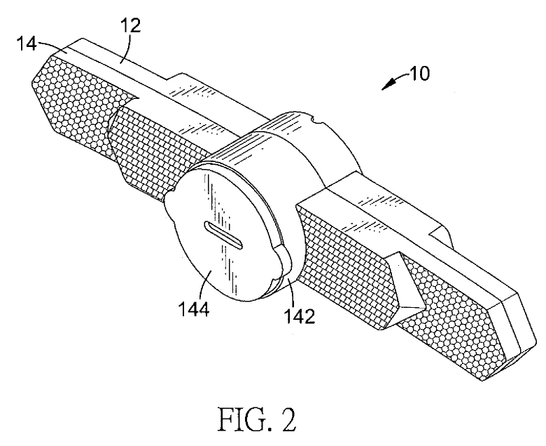

With reference to FIG. 2, the second cover (14) is shaped corresponding to the first cover (12), mounts with the first cover (12) to form the internal space and has a battery container (142), a battery container cover (144) and a seal ring (146).

The battery container (142) is formed on the second cover (14), may be shaped as a rectangular container or a circular container that are respectively suited for containing an alkaline battery or a mercury battery and has an opening, a bottom surface and an electrode hole (1422). In a preferred embodiment of the present invention, the battery container (142) is a circular container that is used for mounting a mercury battery (60) therein. The electrode hole (1422) is formed through the bottom surface of the battery container (1422) so that a containing space of the battery container (142) communicates with the internal space of the case (10).

The battery container cover (144) corresponds to and removably mounts on the opening of the battery container (142).

The seal ring (146) is mounted on the battery container cover (144) and seals the battery container cover (144) securely on the battery container (142) to prevent moisture from leaking into the containing space of the battery container (142).

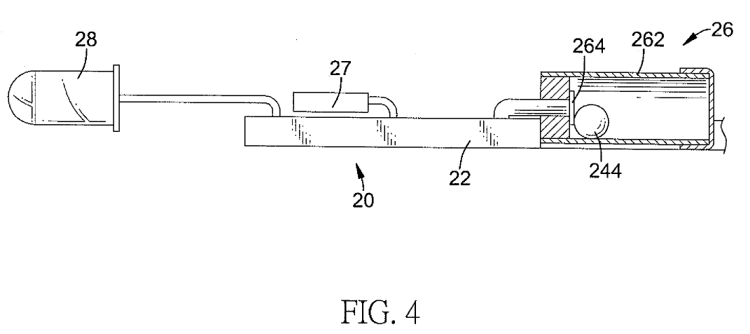

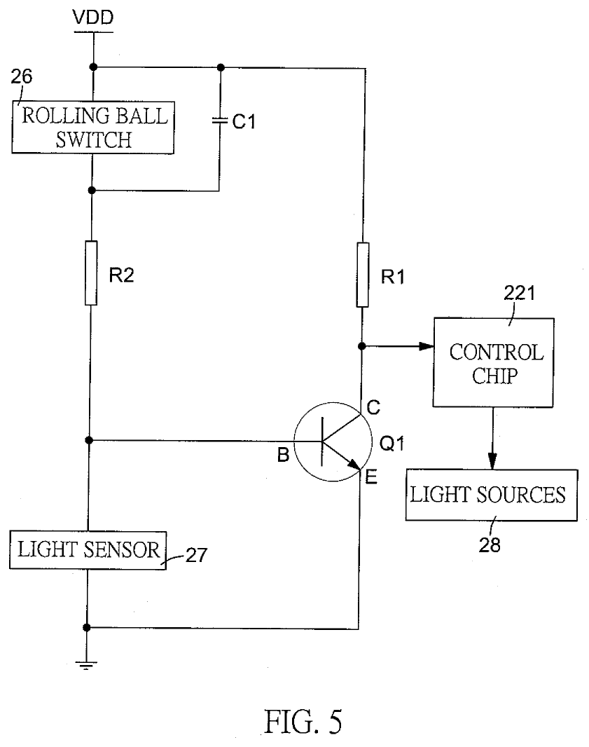

With reference to FIGS. 4 and 5, the electric module (20) corresponds to and is securely mounted in the internal space of the case (10) and has a rolling ball switch (26), a light sensor (27), multiple light sources (28), a battery contact (24) and a control board (22).

The rolling ball switch (26) is electronically mounted on the electric module (20), is alternatively turned on and off when moving and has a primary electrode (262), a secondary electrode (264) and a conducting ball (266). The primary electrode (262) is conductive, is tubular and has an electrode opening. The secondary electrode (264) is electronically isolated to and is mounted on the electrode opening of the primary electrode (262). The conducting ball (266) is conductive and is movably placed inside the primary electrode (262) and selectively connects the secondary electrode (264) with the primary electrode (262) as the rolling ball switch (26) moves. When the bicycle is moving, the conducting ball (266) is moved inside the rolling ball switch (26) with the rolling wheel so that the rolling ball switch (26) is switched ON and OFF with regarding to whether the primary and the secondary electrode (262, 264) are electronically shorted.

The light sensor (27) is electronically mounted on the electric module (20), senses a brightness of environment and may be a photoresistor or a charge-coupled device (CCD). In the preferred embodiment of the present invention, the light sensor (27) is the photoresistor that changes its resistance depends on sensed brightness of the environment.

The light sources (28) may be LEDs and are electronically mounted on the electric module (20).

The battery contact(24) is conductive, is mounted through the electrode hole (1422) into the containing space of the battery container (142) and is electronically connected with the mercury battery (60).

The control board (22) corresponds to and is placed in the internal space of the case (10) and is electronically connected to the rolling ball switch (26), the light sensor (27), the light sources (28) and the battery contact (24). The control board (22) receives power outputted from the mercury battery (60) via the battery contact (24) and controls the light sources (28) to emit light based on detecting results of the light sensor (27) and a status of the rolling ball switch (26). The control board (22) may have multiple fixing holes (222), a control chip (221) and a control circuit.

The fixing holes (222) are formed separately through the control board (22), each fixing holes (222) corresponds to and mounts on one fixing mount (125) after the control board (22) is placed inside the internal space.

The control chip (221) is electronically mounted on the control board (22) and is electronically connected to the control circuit.

The control circuit has a transistor (Q1), a capacitor (C1) and two resistors (R1, R2).

The transistor (Q1) may be a bipolar junction transistor (BJT) or a field effect transistor (FET) that have three terminals. In the preferred embodiment of the present invention, the transistor (Q1) is a BJT with terminals (a first, second and third terminal) of emitter (E), base (B) and collector (C). The emitter (E) is electronically connected to a ground. The light sensor (27) is electronically connected between the base (B) and the emitter (E). The collector (C) connects to the light sources (28) through the control chip (221). The rolling ball switch (26) and the resistor (R2) are connected in series between a voltage source (VDD) and the base (B), wherein the voltage source (VDD) is provided by the mercury battery (60). The capacitor (C1) is connected with the rolling ball switch (26) in parallel. The resistor (R1) is connected between the voltage source (VDD) and the collector (C).

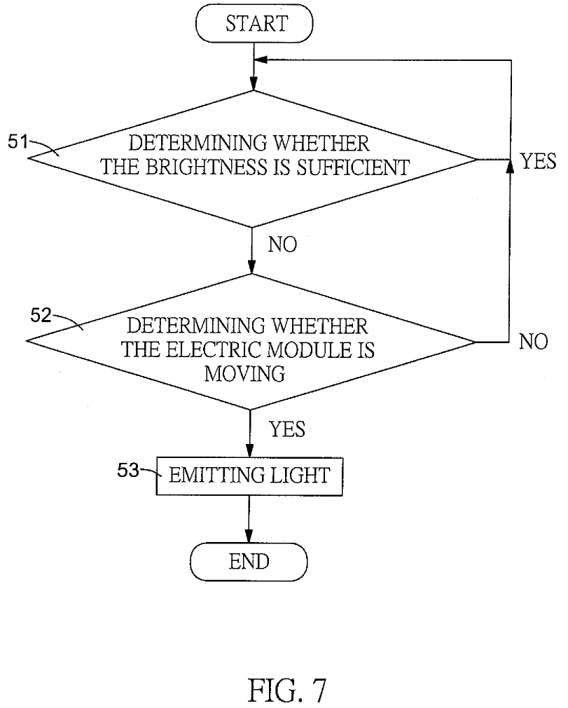

With reference to FIG. 6 and FIG. 7, the electric module (20) emits light by following steps: determining whether the brightness is sufficient (51), determining whether the electric module is moving (52) and emitting light (53). In the step of determining whether the brightness is sufficient (51) and determining whether the electric module is moving (52), the light sensor (27) continuously senses the brightness of the environment and is equivalent to a large resistor when the sensed brightness is lower then a specific value. When the rolling ball switch (26) is moved and is electronically shorted, the transistor (Q) is then turned on and thereby the control chip (22 1) is triggered to activate the light sources (28). Otherwise, the control chip (221) is not triggered and the light sources (28) are not turned on. Furthermore, the light sources (28) may be controlled by the control chip (221) to glisten alternatively.

As described above, the bicycle reflector in accordance with the present invention is capable of outputting light automatically depending on the brightness of the environment and movement of the bicycle. Hence, the power of the bicycle reflector is saved since the bicycle reflector emits light only if the bicycle is running in dark area.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A bicycle reflector comprising
a case having an internal space; and
an electric module corresponding to and being securely mounted inside the internal space and having
a rolling ball switch being alternatively turned on and off when moving;
a light sensor sensing a brightness of environment;
multiple light sources;
a battery contact being conductive and being capable of connecting a battery; and
a control board corresponding to and being placed in the internal space of the case and being electronically connected to the rolling ball switch, the light sensor, the light sources and the battery contact, receiving power outputted from the battery via the battery contact and controlling the light sources to emit light based on detected results of the light sensor and a status of the rolling ball switch, wherein
the control board having a control chip and a control circuit; and
the control circuit being electronically connected to the control chip and having a transistor, a capacitor and two resistors, where the transistor having a first, a second and a third terminal, the first terminal is electronically connected to a ground, the light sensor is electronically connected between the second and the first terminal, the third terminal connects in series to the control chip and the light sources, the rolling ball switch and one of the resistors are connected in series between a voltage source and the second terminal, where the voltage source is provided by the battery, the capacitor is connected with the rolling ball switch in parallel and the other one of the resistors being connected between the voltage source and the third terminal.

2. The bicycle reflector as claimed in claim 1, wherein
the case has
a first cover having
a first inner surface;
a first outer surface;
a spoke recess being formed on the first outer surface;
an mounting recess being a polygon recess formed on the first inner surface of the first cover and being disposed corresponding to the spoke recess; and
multiple fixing mounts separately protruding from the first inner surface of the first cover; and
a second cover being shaped corresponding to the first cover, mounting with the first cover to form the internal space and having
a battery container being formed on the second cover, containing the battery and having
an opening;
a bottom surface; and
an electrode hole being formed through the bottom surface of the battery container;
a battery containing cover corresponding to and selectively covering the opening; and
a seal ring being mounted on the battery container cover and sealing the battery container cover securely on the battery container;
the control board has multiple fixing holes being formed separately through the control board and each fixing hole corresponding to and mounting on one of the fixing mounts; and
the battery contact being mounted through the electrode hole into the containing space of the battery container and being electronically connected with the battery.

3. The bicycle reflector as claimed in claim 1, wherein the light sensor is a photoresistor.

4. The bicycle reflector as claimed in claim 2, wherein the light sensor is a photoresistor.

5. The bicycle reflector as claimed in claim 2, wherein the light sensor is a charge-coupled device.

6. The bicycle reflector as claimed in claim 1, wherein the light sensor is a charge-coupled device.
